(19) United States
(12) Patent Application Publication
(10) Pub. No.: US 2006/0060012 A1
(43) Pub. Date: Mar. 23, 2006

(54) Centrifugal lifting system

(76) Inventor: William S. Barron, Los Banos, CA (US)

Correspondence Address: William S. Barron, 367 Chestnut St., Los Banos, CA, 93635, US

(21) Appl. No.: 10/946,803

(22) Filed: Sep. 23, 2004

(51) Int. Cl. F16H 27/04

(52) U.S. Cl. 74/84 S

(57) ABSTRACT

The present invention provides a device that modifies the centrifugal force of a series of weights held at the perimeter of a rotating assembly by creating an acceleration on the weights perpendicular to their circular path of travel in addition to the centripetal force acting on them. By creating an acceleration on each weight perpendicular to its circular path and by timing when to create the acceleration, the net centrifugal force of the weights can be increased along the top of their rotational path and decreased along the bottom of their rotational path thereby producing a sustainable imbalance that can produce a thrust which propels the device in a particular direction. By using numerous weights on the rotating assembly, a smoother continuous force will be produced. In addition, the present invention can be processed, accelerated or decelerated to produce three dimensional controlling force vectors to add stability to its platform.

### BACKGROUND OF THE INVENTION

1. Field of the Invention

The present invention generally relates to devises that use unbalanced centrifugal force to propel an apparatus in one direction.

2. Description of the Background Art

Various devices that use unbalanced centrifugal force to propel an apparatus in one direction are known within the art. By way of example, US Pub. No. 2004/0069080 of Sordjan Jr. provides a system using unbalanced centrifugal force to propel a vehicle in a unidirectional motion. The device uses unbalanced gears rotating around a fixed central gear thereby producing an unbalanced centrifugal force to produce unidirectional motion.

U.S. Pat. No. 5,937,698 issued to Kunz discloses a propulsion device which employs a belt driven rotor with an aperture larger than the shaft around which it revolves to create a net centrifugal force.

U.S. Pat. No. 4,991,453 issued to Mason, concentrates a centrifugal force by rotating arms at the end which are perpendicularly rotating weighted armlets. The rotating weighted armlets cause variations in the centripetal force resulting in a net force vector.

U.S. Pat. No. 4,238,968 issued to Cook utilizes two counter-rotating arms about a common-axle for generating linear motion. One arm contains a mass, which is splitable as well as transferable to the other arm and back at intervals of one hundred and eighty (180) degrees of rotation.

The history in this field has produced devices that generally have trouble being scaled up to efficiently generate unidirectional forces that are smooth and of sufficient strength to be practical in their use.

### SUMMARY OF THE INVENTION

The present invention provides a device that modifies the centrifugal force of rotating weights by creating an acceleration of the weights perpendicular to their circular path of travel in addition to the centripetal force acting on the object as it rotates through its circular path.

The forces acting on each weight are derived from two sources. The first is centrifugal. According to Newton's Law, centrifugal force is produced as a result of an object which is constantly changing direction. Since changing direction constitutes acceleration, by Newton's law F=MA, a resulting force is produced. Centrifugal force is also directly proportional to the velocity and mass of the object or the radius of the circle through which the mass is traveling. An object undergoing uniform circular motion creates a centrifugal force equal along all points of its path.

The first centrifugal force that is equal on all sides can be modified by the introduction of a second force on each weight by creating an acceleration on it perpendicular to its circular path. According the same law of Newton, F=MA can be used to determine the increase in acceleration of the weight as a force acts on it to move it toward the center of the circular path through which it travels. Also when the path of the object is changed the radius of the circular motion it is undergoing is also changed. When the radius is reduced the centripetal force (acting towards the center of the circle) is changed by the following formula F=MA=MV²/R where “A” is the acceleration and “F” is the centripetal force. “R” is the radius of the circle and “M” is mass of the object.

The acceleration can be further defined by examining the distance through which it is moved and the time it takes to move it there. In a simplistic view, the acceleration of an object equals the distance moved divided by the time is takes to move it there. Therefore as the object is moved more quickly from one point to another through the same distance the acceleration is greater if the initial velocity is the same.

As the centrifugal force of the object increases so does the force necessary and derived when creating an acceleration perpendicular to it radial path. The increased centrifugal force makes the object appear to weight more; so the force necessary to accelerate it through the same distance perpendicular to its radial path is also increased.

By timing when to create the acceleration perpendicular to the radial path, the net centrifugal force of the weights can be increased along the top of their rotational path and decreased along the bottom rotational path thereby producing a sustainable imbalance that can produce a thrust which propels the device in a particular direction.

In addition to lifting propulsion, because it is a rotating mass, the present invention can be precessed, and/or the rotational velocity of it can be accelerated or braked to produce three dimensional controlling forces to add stability to any platform it is attached to when no other stabilizing forces are available.

By using numerous weights on a single rotating system, a smoother continuous force will be produced.

These and other features, aspects and advantages of the present invention will become better understood with reference to the following drawings, description and claims.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1A, FIG. 1B, and FIG. 1C is a simple visual illustration of how the weight of an object changes when it is moved or accelerated.

FIG. 2A is a visual illustration in plan view of how to apply the principal to a simple rotating object, i.e. a weight on the end of a string.

FIG. 3A is a plan view of one embodiment of the present invention. It illustrates a simple rotating platform with two opposing weights. It also displays the approximate areas of acceleration perpendicular to the radial path.

FIG. 3B is a sectional view of the present invention taken from FIG. 3A and similar to the same location in FIG. 4A.

FIG. 4A is a plan view of the present invention. It illustrates a simple rotating platform with multiple opposing weights. It also displays the approximate areas of acceleration perpendicular to the radial path.

FIG. 4B is a sectional view of the present invention taken from FIG. 4A and similar to the same location in FIG. 3A.

FIG. 4C is the back of the present invention in plan view. It illustrates a simple rotating platform with a single stationary cam and multiple cam followers, push rods and rocker arms.

FIG. 5A is a partial sectional view of an alternate embodiment that directly uses a cam to accelerate each weight.

FIG. 6A is a partial sectional view of an alternate embodiment in which the weight is also a piston that uses a combustion process similar to a two cycle engine to accelerate the weight with a rocker arm and cam to hold and release the weight after each combustion cycle.

### DETAILED DESCRIPTION OF THE INVENTION

Referring now descriptively to the drawings, wherein similar reference numbers denote similar elements throughout the several views, the attached figures illustrate concepts, systems and methods according to the present invention.

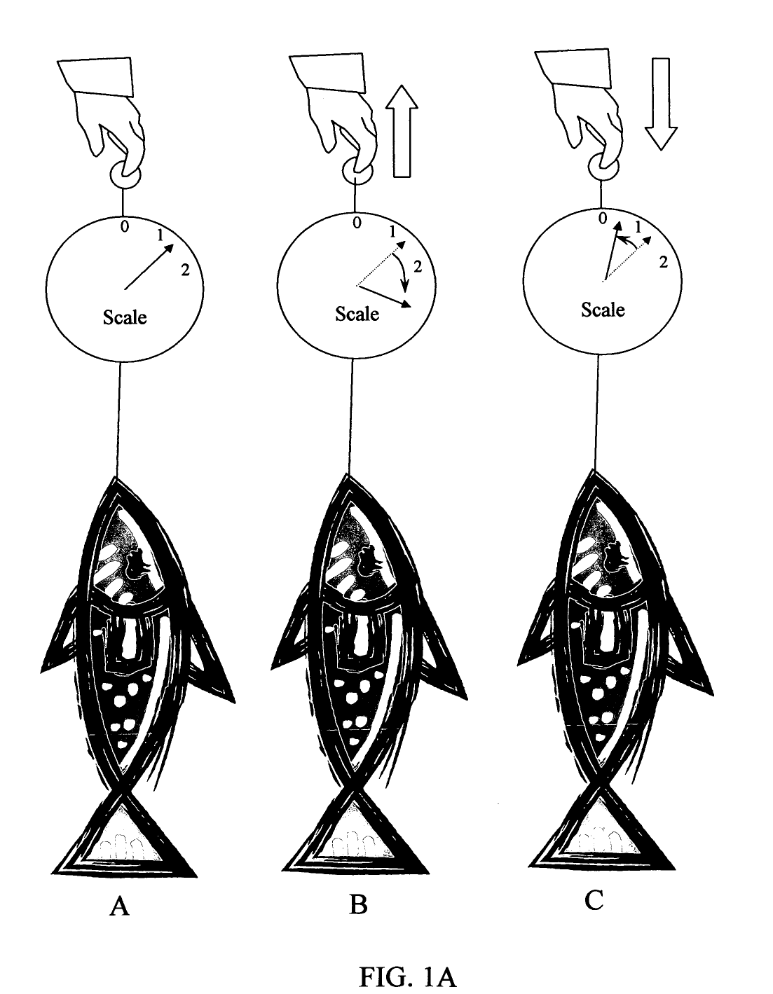

FIG. 1A, FIG. 1B, and FIG. 1C visually depicts what happens when an acceleration acts on an object. As can be seen in illustration FIG. 1A, the normal weight of the object undergoing solely the acceleration of gravity is shown on the scale. However when the object is accelerated in the opposite direction as the acceleration of gravity as shown in illustration FIG. 1B; the weight of the object increases at least briefly as shown on the scale. When the object is released and allowed to accelerate in the same direction as the acceleration of gravity as in illustration FIG. 1C; the weight of the object decreases as shown on the scale.

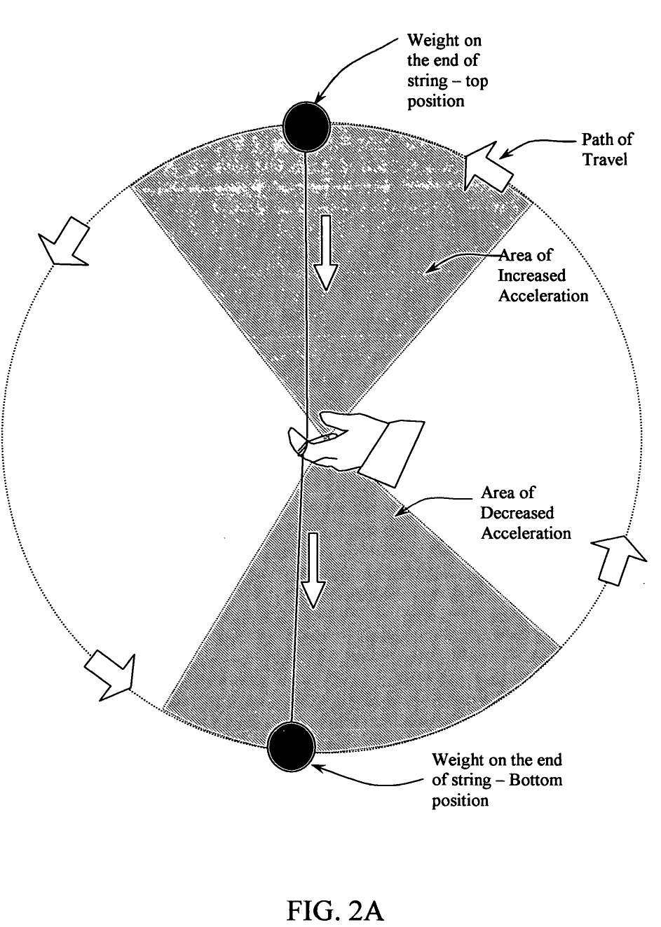

FIG. 2A visually depicts what happens when you apply the concept illustrated in FIG. 1A, FIG. 1B, and FIG. 1C to a rotating object. As can be seen in the illustration, a small weight is attached to a string that is being spun around by a hand. The object is undergoing an acceleration creating a force on the string known as centripetal force. As illustrated in FIG. 1B above when the weight is accelerated against the centrifugal force acting on it, i.e. the string is suddenly pulled a short distance toward the center, the tension on the string will be briefly increased. The area of increased acceleration is illustrated by a darker pie shaped area approximately 45 degrees either side of the top. However when the object is allowed to move in the same direction as the centrifugal acceleration, i.e. the string is released a small amount along the bottom as illustrated by a darker pie shaped area approximately 45 degrees either side of bottom, the tension on the string will be decreased briefly. The difference between the increased and decreased acceleration areas will result in a net force acting on the system.

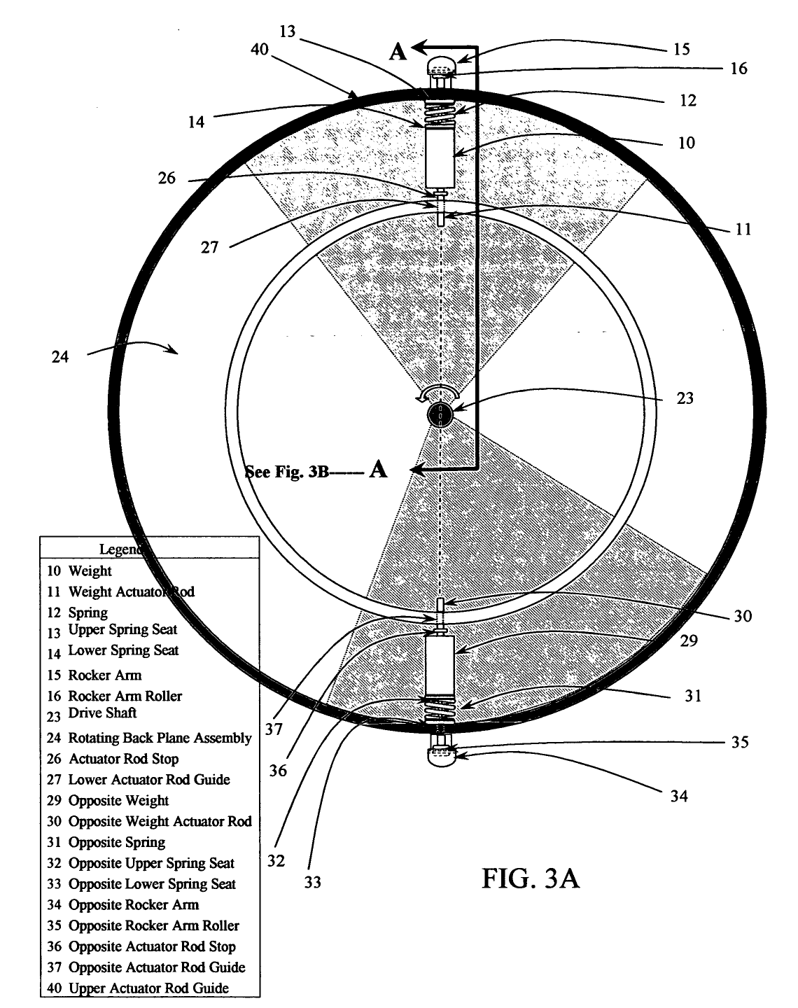

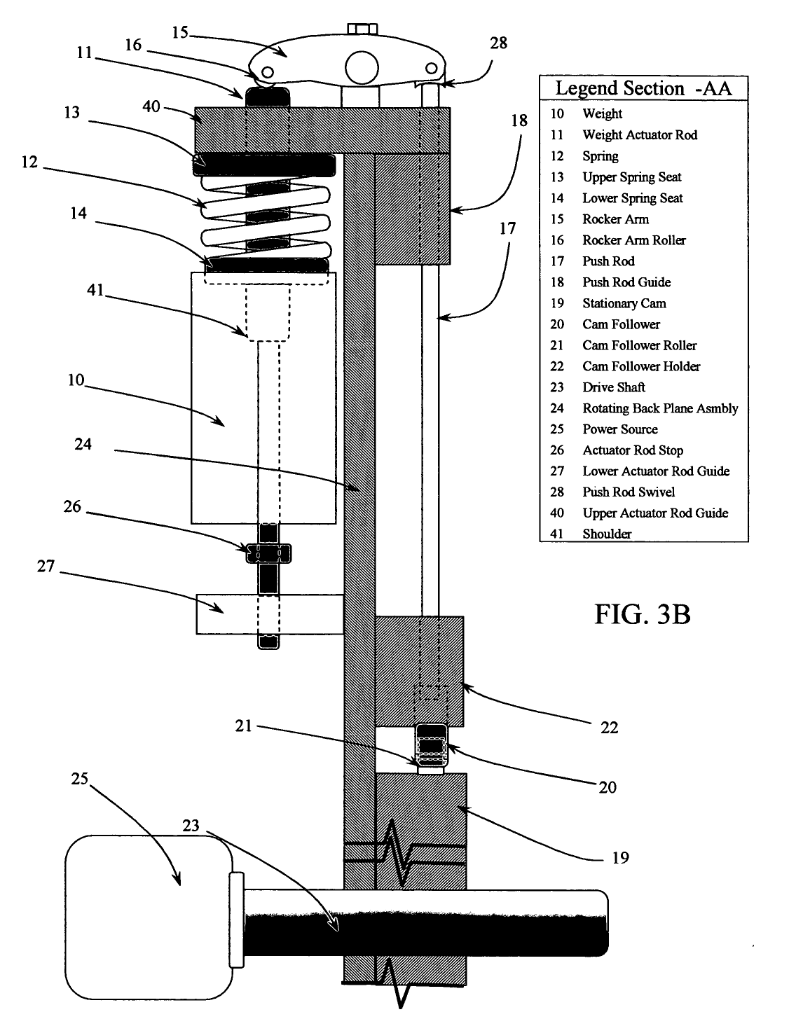

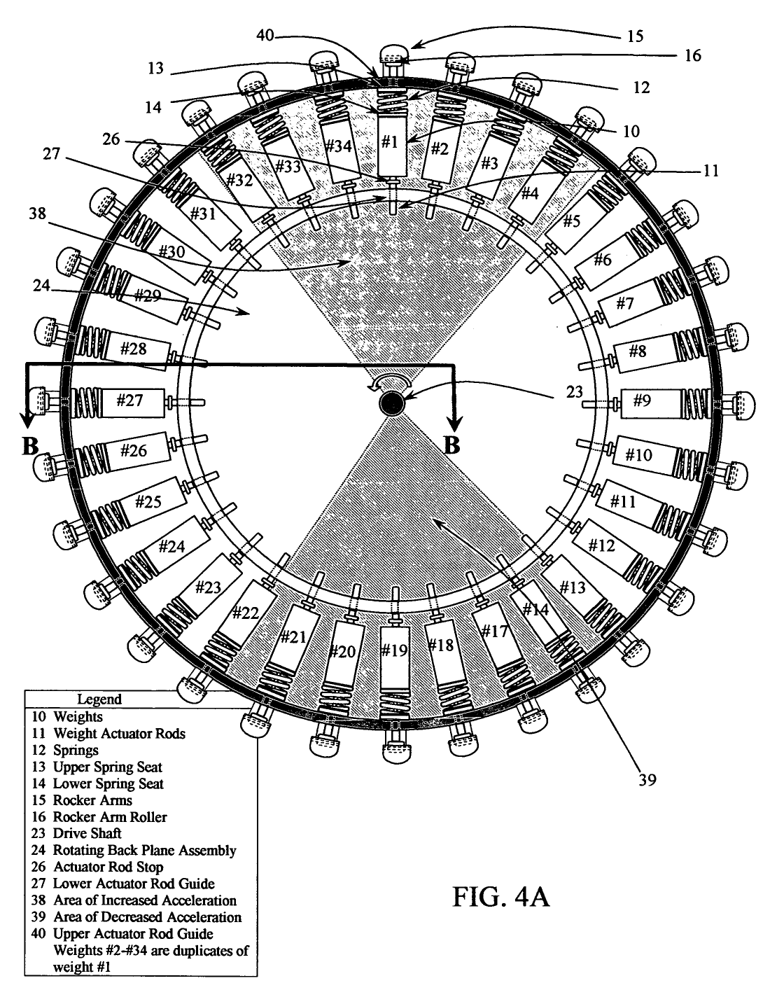

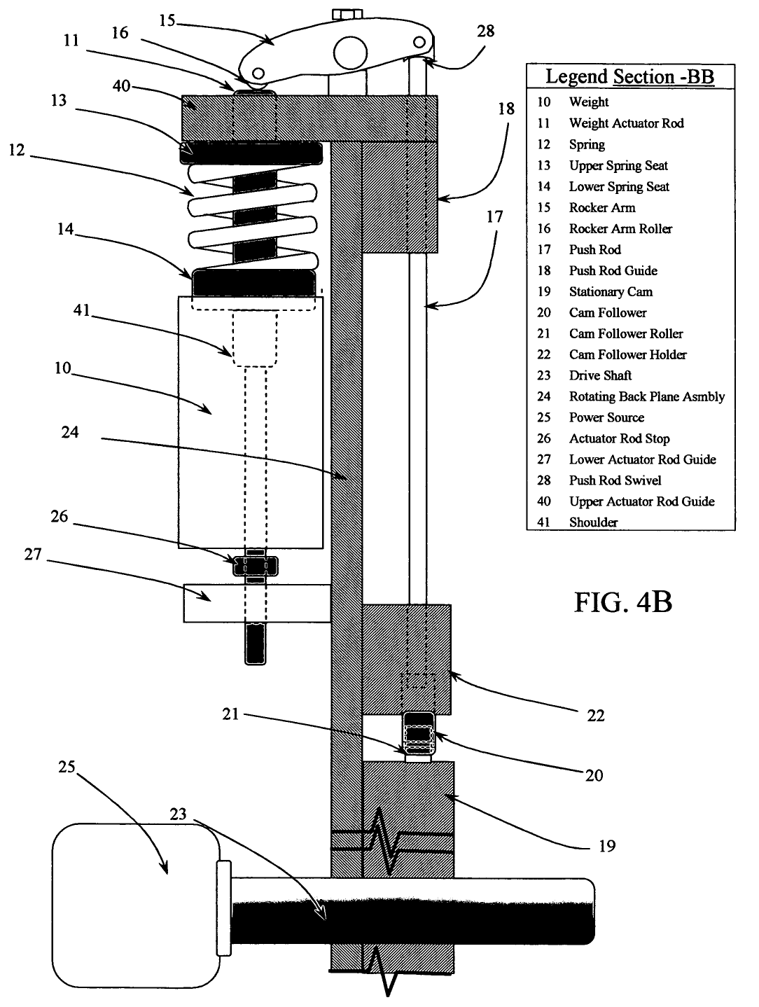

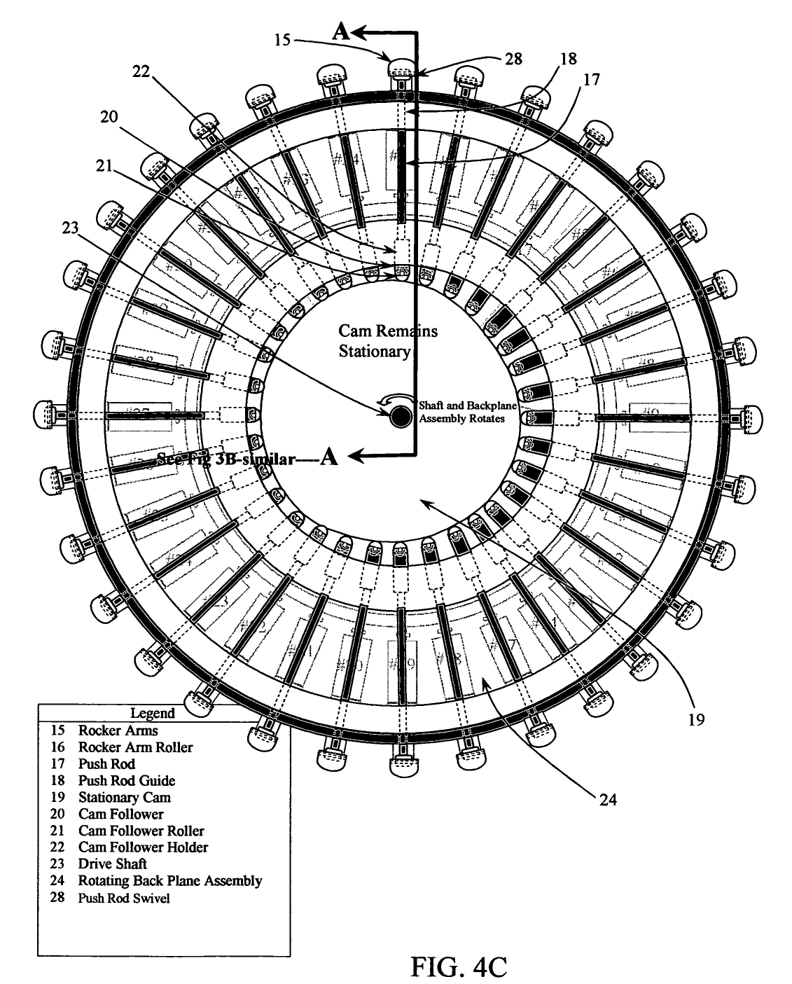

FIG. 3A being one embodiment of the invention depicts a shaft 23 that provides rotation in a counter clockwise direction of the backplane assembly 24 being the entire surface upon which other items are mounted. The shaft is being rotated by a motor/power source depicted in FIG. 3B as 25. The lower actuator rod guide 27 and the upper actuator rod guide 40 provide support for the weight actuator rod 11 which passes through weight 10 upper spring seat 13 which seats against the upper actuator rod guide 40 and spring 12 and lower spring seat 14. The opposite weight actuator rod 30 in the same manner passes through opposite weight 29 opposite upper spring seat 32 opposite spring 31 and opposite lower spring seat 33. Both actuator rods slide easily through their supports and press against a shoulder depicted in FIG. 4B as 41 so that when the rod is depressed by the rocker arm 15 which is actuated by pushrod 17 and cam 19 on the opposite side depicted in FIG. 3B and FIG. 4C similar the weight moves toward shaft 12 at the center of the backplane assembly 24. The opposite rocker arm 34 is actuated in the same manner by pushrod 17 and cam 19 (which is held stationary and does not rotate) on the opposite side depicted in FIG. 3B and FIG. 4C. Each rocker arm has a roller 16 and 35 at the end to reduce friction where they press against the actuator rods. When the backplane assembly 24 is rotating, spring 12 stores energy to help accelerate weight 10 when Rocker Arm 15 depresses actuator rod 11. Cam 19 (which is held stationary and does not rotate) depicted in FIG. 3B and FIG. 4C is similar to that used for FIG. 3A is shaped so that it causes rocker arm 15 to depress weight actuator rod 11 which will accelerate weight 10 downward as it passes through the shaded area at the top shown as the Area of Increased acceleration 38 in FIG. 4A which is the same in this figure. Cam 19 (which is held stationary and does not rotate) depicted in FIG. 3B and FIG. 4C is similar to that used for FIG. 3A is shaped so that it causes opposite rocker arm 34 to partially release opposite weight actuator rod 30 which will reduce the acceleration of opposite weight 29 as it passes through the shaded area at the bottom shown as the Area of decreased acceleration 39 in FIG. 4A which is the same in this figure. The upper and lower spring seats generally provide stability for the springs by capturing each end of the springs and ensure they remain properly placed. As the rotational speed increases the weight spends less time in the areas of increased and decreased acceleration. If the device is rotating at one thousand revolutions per minute it will only will take fifteen one hundredths of a second to pass through the area of increased acceleration 38. As a result each weight only needs to be accelerated a small distance perpendicular to the circular path of travel during that small time interval to create an increased force vector on weight 10.

FIG. 4A being one embodiment of the invention depicts a shaft 23 that provides rotation in a counter clockwise direction of the backplane assembly 24 being the entire surface upon which other items are mounted including thirty four weight assemblies as depicted by FIG. 4B. Shaft 23 is being rotated by a motor/power source depicted in FIG. 4B as 25. Each weight assembly numbered one through thirty four is identical except that they are evenly spaced around the perimeter of backplane assembly 24. Each weight assembly operates in this fashion. The lower actuator rod guide 27 and the upper actuator rod guide 40 provide support for the weight actuator rod 11 which passes through weight 10, upper spring seat 13 which seats against the upper actuator rod guide 40 and spring 12 and lower spring seat 14. The upper and lower spring seats of each spring provides stability for the springs by capturing each end of the springs and ensure they remain properly placed. Each actuator rod slides easily through their supports and press against a shoulder depicted in FIG. 4B as 41 so that when the rod is depressed by the rocker arm 15 which is actuated by pushrod 17 and cam 19 (which is held stationary and does not rotate) on the opposite side depicted in FIG. 4B and FIG. 4C the weight 10 moves toward shaft 12 at the center of the backplane assembly 24. Each rocker arm has a roller similar to 16 at the end to reduce friction where it presses against the actuator rods. When the backplane assembly 24 is rotating, spring 12 stores energy to help accelerate weight 10 when Rocker Arm 15 depresses actuator rod 11. Cam 19 (which is held stationary and does not rotate) depicted in FIG. 4B and FIG. 4C is similar to that used for FIG. 3A is shaped so that it causes rocker arm 15 to depress weight actuator rod 11 which will accelerate weight 10 downward as it passes through the shaded area at the top shown as the Area of Increased acceleration 38 in FIG. 4A. Cam 19 (which is held stationary and does not rotate) depicted in FIG. 3B and FIG. 4C is similar to that used for FIG. 3A is shaped so that it hold the weights at a steady distance from shaft 23 until when is enters the area of decreased acceleration 39 it then causes rocker arm 15 to partially release weight actuator rod 11 which will reduce the acceleration of weight 10 as it passes through the shaded area at the bottom shown as the Area of decreased acceleration 39 in FIG. 4A. After the weight rotates past the area of decreased acceleration 39, Cam 19 (which is held stationary and does not rotate) depicted in FIG. 3B and FIG. 4C is shaped so that it hold the weights at a steady distance from shaft 23 until when is enters the area of increased acceleration 38 where it causes opposite rocker arm 15 to depress weight actuator rod 11 which will accelerate weight 10 downward as it passes through the shaded area at the top shown as the Area of Increased acceleration 38 in FIG. 4A. Each and every weight assembly follows the same path with the weight moving in and out in relation to the center shaft as the shape of cam 19 dictates. As with 3A above, as the rotational speed increases the weight spends less time in the areas of increased and decreased acceleration. If the device is rotating at one thousand revolutions per minute it will only will take fifteen one hundredths of a second to pass through the area of increased acceleration 38. As a result each weight only needs to be accelerated a small distance perpendicular to the circular path of travel during that small time interval to create an increased force vector on weight 10.

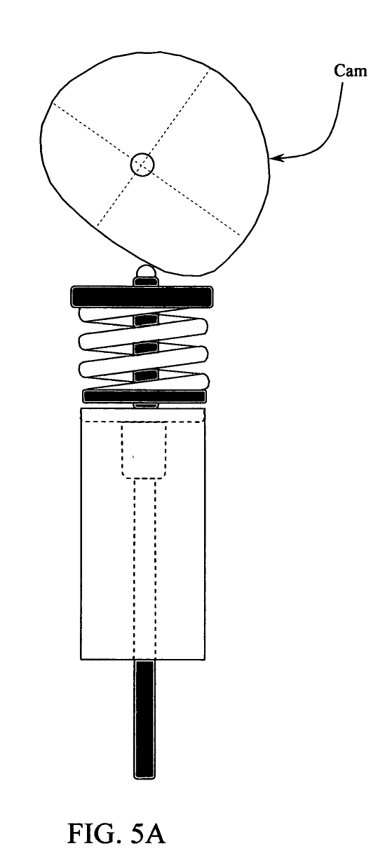

FIG. 5A being one possible alternate embodiment of the invention which depicts a partial sectional view of an alternate embodiment that uses a cam similar in shape to cam 19 but smaller to directly actuate weight actuator rod 11 which passes through weight 10, upper spring seat 13 which seats against the upper actuator rod guide 40 and spring 12 and lower spring seat 14. Each cam is attached to a gear that provides a rotational speed one to one with backplane assembly 24 Other than that all layout and principals are similar to FIG. 4A. Since it has the cam directly activating actuator rod 11 it does not need pushrods or cam followers.

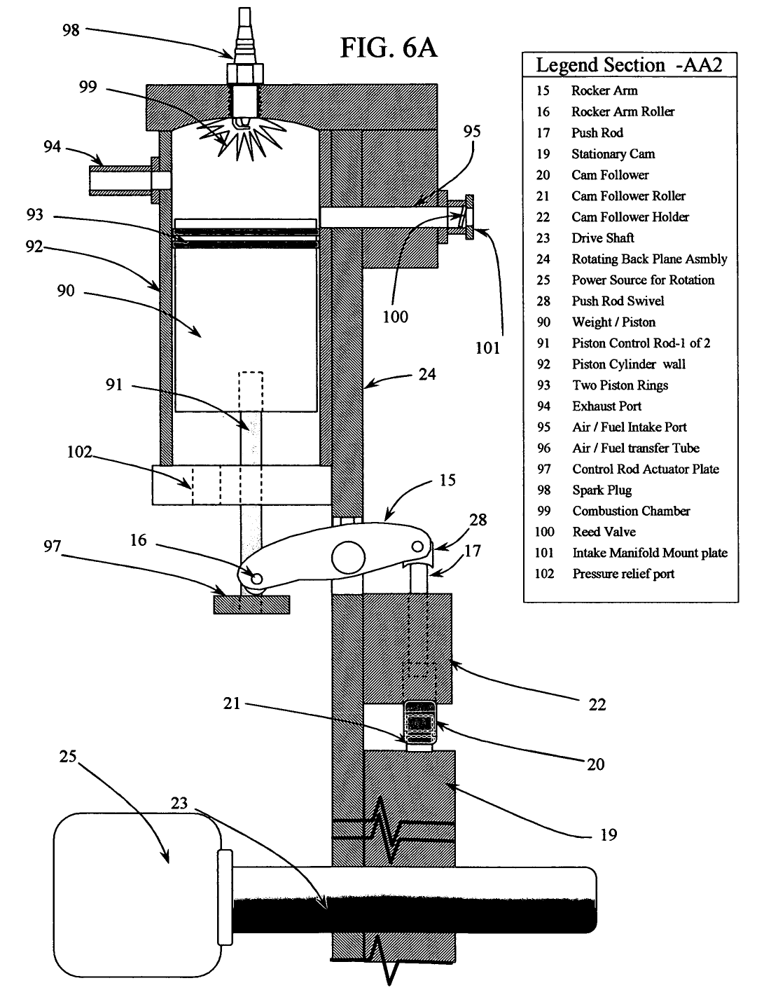

FIG. 6A is a partial sectional view of an alternate embodiment of the invention in which weight 10 of the other embodiments of the invention instead becomes, weight/Piston 90 which is also a piston with Two rings 93 that uses Air/Fuel Intake Port 95 to intake a combustive air fuel mixture and Spark plug 98 to ignite it and begin a combustion process similar to a two cycle engine that then exhausts the burned gas out Exhaust Port 94. The increased pressure of the combustion gases expanding in combustion chamber 99 creates a force equal against the top of the chamber and against the weight/Piston 90 to accelerate weight/Piston 90 toward shaft 23 as it passes through the shaded area at the top shown as the Area of Increased acceleration 38 in FIG. 4A. Rocker arm 15 and cam 19 (which is held stationary and does not rotate) will hold weight/Piston 90 at a steady distance from shaft 23 until when it enters the area of decreased acceleration 39 then cam 19 causes rocker arm 15 to steadily allow piston control rod 91 to be released as it passes through the shaded area at the bottom shown as the Area of decreased acceleration 39. When weight/Piston 90 is fully released by allowing cam 19 to let Push Rod 17 move toward shaft 23 which in turn will allow rocker arm 15 to be raised sufficiently so that control rod 91 does not press against it but instead is fully pressing on the now compressed air fuel mixture. The centrifugal force of weight/Piston 90 provides sufficient force to compress the fresh combustive air fuel mixture that has entered the combustion chamber after the exhaust gases have exited when it is fully released. The diameter and the mass of the piston along with the rotational velocity of the assembly can be varied to provide an optimal compression ratio and reactive speed. The compressed air fuel mixture is now ready for Spark plug 98 to fire and begin combustion when weight/Piston 90 rotates into the Area of Increased acceleration 38 FIG. 4A. This partial sectional view of an alternate embodiment of the invention indicates what one section similar to FIG. 4B Section BB would look like on an invention with all weights, one through thirty four instead being like combination weight/Piston 90.

The invention being thus described, it will be obvious that the same may be varied in many ways. Such variations are not to be regarded as a departure from the spirit and scope of the invention. All such modifications as would be obvious to one skilled in the art are intended to be included within the scope of the following claims.

What I claim as my invention is:

1. Comprised of the several embodiments described below each including:
a series of actuatable weights that can be moved in and out a short distance along a straight line path that passes through the center of rotation of the assembly and that is perpendicular to their circular path with each equal in mass and evenly spaced around and attached to the perimeter of the backplane assembly;
a mechanism to move each weight using either mechanical, chemical, magnetic or electrical force to accelerate the weights perpendicular to their circular path toward the center of the rotating backplane assembly for approximately forty five degrees or less either side of the top of the circular path and to allow it to return to its original position/distance from the center of rotation as it follows its path approximately forty five degrees either side of the bottom of the circular path;
a possibility to precess the gyroscopic rotating mass of the weights and backplane assembly and/or accelerate or brake the rotational mass of the assembly in a controlled fashion to produce three dimensional controlling forces to add stability to any platform it is attached to when no other stabilizing forces are available; and
a device to provide rotation of the backplane assembly such as an electric motor, and further including a speed control for controlling the speed of said motor with the same constituent assembled parts.

2. A device for the conversion of centrifugal force to linear force and motion comprising:
a central shaft that would be mounted to a frame/vehicle which is not shown;
a backplane assembly attached rigidly to the central shaft;
a cam that centers on the central shaft but is not attached to the central shaft or backplane assembly and does not rotate with the central shaft and backplane assembly but is directly adjacent to it;
a series of actuatable weights equal in mass and evenly spaced around the perimeter of the backplane assembly and aligned perpendicular to the perimeter, each with the same constituent assembled parts;
a actuator rod passing through each actuatable weight;
a guide with a hole for the actuator rod at the upper and lower end of the rod that allows the rod to slide through it;
a spring with a seat on each end between the actuatable weight and the upper actuator rod guide;
a rocker arm mounted on the outside edge of the backplane assembly that actuates the actuator rod;
a push rod on the back side of the backplane assembly that actuates the rocker arm and seats in the cam follower at the bottom; and
a cam follower that rolls against the outside contour of the cam and slides through its holder to push against the push rod that slides through the upper and lower holders and pushes against the rocker arm.

3. A device according to claim 2, wherein the cam is shaped so that it pushes the cam follower out from the center of the rotating backplane assembly for approximately forty five degrees either side of the top and to allow it to return toward the center approximately forty five degrees either side of the bottom.

4. A device according to claim 2, wherein the spring compresses when the weight is released by the rocker arm to press against it along the bottom side of its rotational path thereby storing energy to help accelerate the weight toward the center along the top of its rotational path when the rocker arm presses against the weights actuator rod to accelerate it toward the center.

5. A device according to claim 2, wherein the quantity, mass, rotational velocity and radius of the path of the weights mounted to the rotating backplane assembly which is used to convert centrifugal motion to unidirectional motion may be varied depending on the desired lifting force to be produced.

6. A device according to claim 2, wherein said drive source is an electric motor, and further including a speed control for controlling a speed of said motor.

7. A device for the conversion of centrifugal force to linear force and motion comprising:
a central shaft that would be mounted to a frame/vehicle which is not shown;
a backplane assembly attached rigidly to the central shaft;
a series of actuatable weights equal in mass and evenly spaced around the perimeter of the backplane assembly and aligned perpendicular to the perimeter, each with the same constituent assembled parts;
a actuator rod passing through each actuatable weights;
a guide with a hole for the actuator rod at the upper and lower end of the rod that allows the rod to slide through it;
a spring with a seat on each end between the actuatable weight and the upper actuator rod guide;
a cam whose shaft is mounted on the outside edge of the backplane assembly adjacent to each weight and that rotates against and actuates the actuator rod of each weight; and
a gear assembly that rotates each cam on a one to one ratio with the backplane assembly.

8. A device according to claim 7, wherein the cam is shaped so that it pushes the actuator rod toward the center of the rotating backplane assembly for approximately forty five degrees either side of the top and to allow it to be released away from the center of the assembly approximately forty five degrees either side of the bottom.

9. A device according to claim 7, wherein the spring compresses when the weights actuator rod is released by the cam to press against it along the bottom side of its rotational path thereby storing energy to help accelerate the weight toward the center along the top of its rotational path when the cam rotates against the weights actuator rod to accelerate it toward the center.

10. A device according to claim 7, wherein the quantity, mass, rotational velocity and radius of the path of the weights mounted to the rotating backplane assembly which is used to convert centrifugal motion to unidirectional motion may be varied depending on the desired lifting force to be produced.

11. A device according to claim 7, wherein said drive source is an electric motor, and further including a speed control for controlling the speed of said motor.

12. A device for the conversion of centrifugal force to linear force and motion comprising:
a central shaft that would be mounted to a flame/vehicle which is not shown;
a backplane assembly attached rigidly to the central shaft;
a series of cylinders closed off at the outside end, evenly spaced around and fastened to the perimeter of the backplane assembly and aligned perpendicular to the circumference of the circular backplane assembly with an exhaust port and intake port arranged similar to a two cycle gasoline engine with a spark plug on the top of each cylinder and a reed valve in each intake port, each with the same constituent assembled parts;
a series of weights that are also pistons equal in mass placed inside of the cylinders;
a piston control rod made up of two rods that pass through a guide on the bottom of the cylinder and connect to the bottom of each piston/weight and that has a surface between them for a rocker arm to press against;
a rocker arm mounted to the backplane assembly that actuates the piston control rod;
a push rod on the back side of the backplane assembly that actuates the rocker arm and seats in the cam follower; and
a cam follower that rolls against the outside contour of the cam and slides through its holder to push against the push rod that slides through the holder and pushes against the rocker arm.

13. A device according to claim 12, wherein the work of accelerating the weight/piston is accomplished through the force of the chemical reaction of combustion of a flammable material such as gasoline that is activated and timed by the ignition of the sparkplug.

14. A device according to claim 12, wherein the cam is shaped so that it pushes the cam follower out from the center of the rotating backplane assembly for approximately forty five degrees either side of the top and to allow it to return toward the center approximately forty five degrees either side of the bottom. The action of the cam and rocker arm are only to catch, hold and release the weight/piston after each combustion cycle.

15. A device according to claim 12, wherein the rocker arm holds and begins releasing the weight/piston approximately forty five degrees before bottom of each rotation and allows it to be fully released approximately forty five degrees after the bottom of each rotation. Once the weight/piston is released, centrifugal force presses it against the end of the cylinder sufficiently to provide compression of the combustible material thereby preparing for the next cycle where the spark plug is timed to ignite it approximately forty five degrees before it reaches the top of each rotation.

16. A device according to claim 12, wherein the quantity, mass, rotational velocity and radius of the path of the weights/pistons in the cylinders mounted to the rotating backplane assembly which is used to convert centrifugal motion to unidirectional motion may be varied depending on the desired lifting force to be produced.

17. A device according to claim 12, wherein said drive source for the backplane assembly is an electric motor, and further including a speed control for controlling the speed of said motor.
